(19) United States
(12) Patent Application Publication
(10) Pub. No.: US 2026/0029926 A1
(43) Pub. Date: Jan. 29, 2026

(54) MIGRATING DATA BASED ON WORDLINE INFORMATION IN A MEMORY SUB-SYSTEM

(71) Applicant: Micron Technology, Inc., Boise, ID (US)

(72) Inventors: Hanping Chen, San Jose, CA (US); Go Shikata, San Jose, CA (US); Chao-Han Cheng, San Jose, CA (US); Peng Zhang, Los Altos, CA (US); Murong Lang, San Jose, CA (US); Ching-Huang Lu, Fremont, CA (US); Zhenming Zhou, San Jose, CA (US); Aaron Lee, Sunnyvale, CA (US); Yu-Chung Lien, San Jose, CA (US); Tawalin Opastrakoon, Boise, ID (US)

(21) Appl. No.: 18/787,941

(22) Filed: Jul. 29, 2024

(51) Int. Cl. G06F 3/06

(52) U.S. Cl. CPC G06F 3/0619; G06F 3/0647; G06F 3/0679

(57) ABSTRACT

Various aspects of the present disclosure relate to a memory sub-system for migrating data based on wordline information. A processing device received data from a host system and writes the data to a first memory portion of the memory device. The processing device determines to move at least a subset of data stored in the first memory portion of the memory device to a second memory portion of the memory device configured as multiple-level cell (XLC) memory, the subset of data being associated with a first wordline of the plurality of wordlines. The processing device obtains information associated with a second wordline of the plurality of wordlines, the second wordline being adjacent to the first wordline. The processing device performs a data migration operation, using the information associated with the second wordline, to move the subset of data from the first memory portion to the second memory portion.

### TECHNICAL FIELD

Aspects of the disclosure relate generally to memory sub-systems, and more specifically, to migrating data based on wordline information in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various aspects of the disclosure.

FIG. 1 illustrates an example computing system that includes a memory sub-system, in accordance with some aspects of the present disclosure.

FIG. 2 is a sequence diagram illustrating an example method of migrating data from single-level cell memory to multiple-level cell memory based on wordline information, in accordance with some aspects of the present disclosure.

FIG. 3 is a sequence diagram illustrating an example method of migrating data from first multiple-level cell memory to second multiple-level cell memory based on wordline information, in accordance with some aspects of the present disclosure.

FIG. 4 is a sequence diagram illustrating an example method of migrating data based on wordline information and a characteristic of a single-level cell cache, in accordance with some aspects of the present disclosure.

FIG. 5 is a flow diagram of an example method of migrating data from single-level cell memory to multiple-level cell memory based on wordline information, in accordance with some aspects of the present disclosure.

FIG. 6 is a flow diagram of an example method of migrating data from first multiple-level cell memory to second multiple-level cell memory based on wordline information, in accordance with some aspects of the present disclosure.

FIG. 7 is a flow diagram of an example method of migrating data based on wordline information and a characteristic of a single-level cell cache, in accordance with some aspects of the present disclosure.

FIG. 8 is a block diagram of an example computer system in which some aspects of the present disclosure may operate.

### DETAILED DESCRIPTION

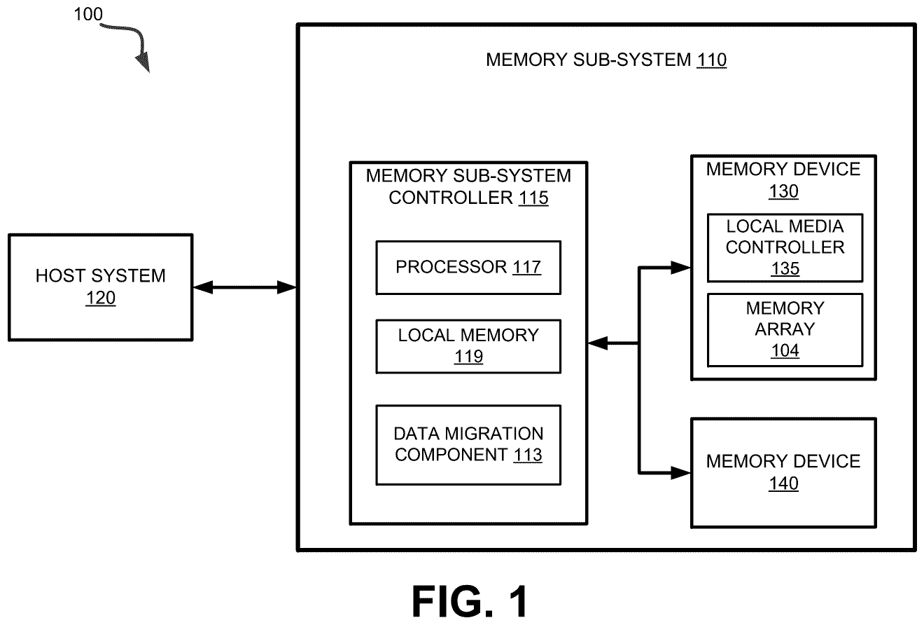

Aspects of the present disclosure are directed to migrating data based on wordline information in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in a rectangular array; the memory cells may be joined by conductive lines referred to as wordlines and bitlines. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Single-level cell (SLC) memory and multiple-level cell (XLC) memory are two types of non-volatile memory used in memory devices. SLC memory stores one bit of information per cell, which can make it more reliable, faster, and durable than other types of memory. In contrast, multiple-level cell (XLC) memory stores multiple bits of information per cell, which can increase data storage density in the memory device. One type of XLC memory is triple-level cell (TLC) memory, which stores three bits of information per cell. A wordline (WL) is a control line in a memory device used to select a row of memory cells in an array for reading or writing operations. In the context of non-volatile memory, such as NAND flash memory, the wordline is a horizontal conductor that connects to the gates of a series of memory cells in the same row. When a specific wordline is activated, it allows access to the memory cells in that row for operations such as reading the stored data, writing new data, or erasing the data.

Data migration is a crucial process for maintaining optimal performance and longevity of a memory device. One example type of data migration is data folding, which involves moving data from one part of the memory to another to improve wear leveling and to reclaim blocks of memory for future use. Data folding can be performed to manage the limited write endurance of flash memory by evenly distributing write and erase cycles across the memory cells. Two examples of data migration and data folding are garbage collection and media scanning. Garbage collection is a process in memory devices that reclaims space by consolidating valid data and erasing blocks containing invalid or obsolete data. In contrast, media scanning is a maintenance process that periodically checks and relocates data to prevent corruption and ensure data integrity by identifying and correcting errors in memory cells. Data retention refers to the ability of the memory device to maintain stored information over time without power. Data retention can deteriorate over time due to lateral charge migration, where charge gradually leaks from one cell to adjacent cells. This issue can be exacerbated by smaller distance between wordlines in the memory array, which can be referred to as a WL pitch. As the WL pitch decreases, the proximity of the cells increases the likelihood of charge leakage, leading to a faster decline in data retention.

A corrective program operation is a maintenance process designed to address and correct errors in stored data by adjusting the charge levels in memory cells. Over time, various factors such as charge leakage, program/erase cycles (PEC), and environmental conditions can cause the charge levels in memory cells to drift, leading to potential data errors. During a corrective program operation, the memory controller identifies cells with deviating charge levels and rewrites the data to these cells to restore the correct charge levels. This operation may involve reading the data from the affected cells, correcting any detected errors using error correction codes (ECC), and then reprogramming the cells with the accurate data.

High temperatures can impact data retention in memory devices by accelerating charge leakage, increasing cell wear, and heightening error susceptibility. For example, high temperatures can exacerbate wear on the memory device by increasing atomic and molecular movement, accelerating damage to the insulating layers. This results in quicker charge leakage and reduced data retention capabilities. Additionally, high temperatures can reduce the reliability of distinguishing charge levels, thereby increasing the likelihood of read and write errors, particularly in multi-level cell memories where slight charge variations can lead to incorrect data. Prolonged exposure to high temperatures, known as long bake, further exacerbates these issues. Long bake conditions, including those found in hot environments such as cars parked in the hot sun or a parking garage, accelerate charge loss, increase error rates, and heighten the risk of permanent data corruption. These conditions are especially challenging for high-density memory types such as XLC memory which are already more prone to charge leakage and wear.

Aspects of the present disclosure address the above and other deficiencies by migrating data based on wordline information in a memory sub-system. A memory sub-system controller of the memory sub-system may receive data from a host system and write the data to a first memory portion of a memory device. In some aspects, the first memory portion of the memory device may be configured as SLC memory. In some other aspects, the first memory portion of the memory device may be configured as XLC memory, such as TLC memory. In some aspects, the memory sub-system controller may write the data to the first memory portion of the memory device based on a condition of an SLC cache. For example, the memory sub-system controller may determine whether the SLC cache is in a full state and may write the data to the SLC memory when the SLC cache is not in the full state or to the XLC memory when the SLC cache is in the full state. The memory sub-system controller may determine to move at least a subset of data stored in the first memory portion of the memory device to a second memory portion of the memory device configured as XLC memory. The first portion of the memory device may be associated with a first wordline. In some aspects, the memory sub-system controller may determine to move the subset of data from the first memory portion to the second memory portion in accordance with a media scan operation or a garbage scan operation. In some other aspects, the memory sub-system controller may determine to move the subset of data from the first memory portion to the second memory portion in accordance with an active data migration operation. The memory sub-system controller may obtain information associated with a second wordline that is adjacent to the first wordline. For example, the memory sub-system controller may determine whether the second wordline is in a high state or a low state. The memory sub-system controller may perform a data migration operation, such as a data folding operation, using the information associated with the second wordline, to move the subset of data from the first memory portion to the second memory portion.

Some advantages of the present disclosure include, but are not limited to, improving memory device data retention. For example, some advantages of the present disclosure include performing corrective program operations using information from adjacent wordlines, thereby leading to increased data retention capabilities of the memory device. Additionally, some advantages of the present disclosure include improving memory device data retention despite increasing lateral charge migration. Some advantages of the present disclosure include reducing media scan complexities. Some advantages of the present disclosure include improved quality of service within the memory sub-system. Some advantages of the present disclosure include reducing a frequency of data migration operations, such as data folding operations resulting from long bake conditions. Some advantages of the present disclosure include increasing a longevity of the memory device. For example, some advantages of the present disclosure include reducing total bytes written to the memory device, thereby increasing the durability of the memory device. These example advantages, among others, are described in more detail below.

FIG. 1 illustrates an example computing system 100 that includes a memory sub-system 110, in accordance with some aspects of the present disclosure. The memory sub-system 110 can include media, such as one or more volatile memory devices (e.g., memory device 140), one or more non-volatile memory devices (e.g., one or more memory device(s) 130), or a combination of such.

The memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some aspects, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some aspects, each of the memory devices 130 can include one or more arrays of memory cells such as SLCs, MLCs, TLCs, QLCs, or any combination of such. In some aspects, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some aspects, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in some other aspects, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some aspects, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some aspects, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some aspects, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some aspects, one or more components of memory sub-system 110 can be omitted.

In some aspects, the memory sub-system 110 includes a data migration component 113 that can be used to migrate data based on wordline information. For example, the data migration component 113 may move data, such as data received from the host system 120, from a first memory portion of the memory device 130 to a second memory portion of the memory device 130. In some aspects, the data migration component 113 may determine to move the data from the first memory portion to the second memory portion in accordance with a media scan operation or a garbage scan operation. In some other aspects, the data migration component 113 may determine to move the data from the first memory portion to the second memory portion in accordance with an active data migration operation. The first memory portion may be associated with a first wordline of a plurality of wordlines of the memory device. The data migration component 113 may obtain information associated with a second wordline that is adjacent to the first wordline. For example, the data migration component 113 may determine whether the second wordline is in a high state or a low state. The data migration component 113 may perform a data migration operation, such as a data folding operation, using the information associated with the second wordline, to move the data from the first memory portion to the second memory portion. Additional details regarding these features are described below.

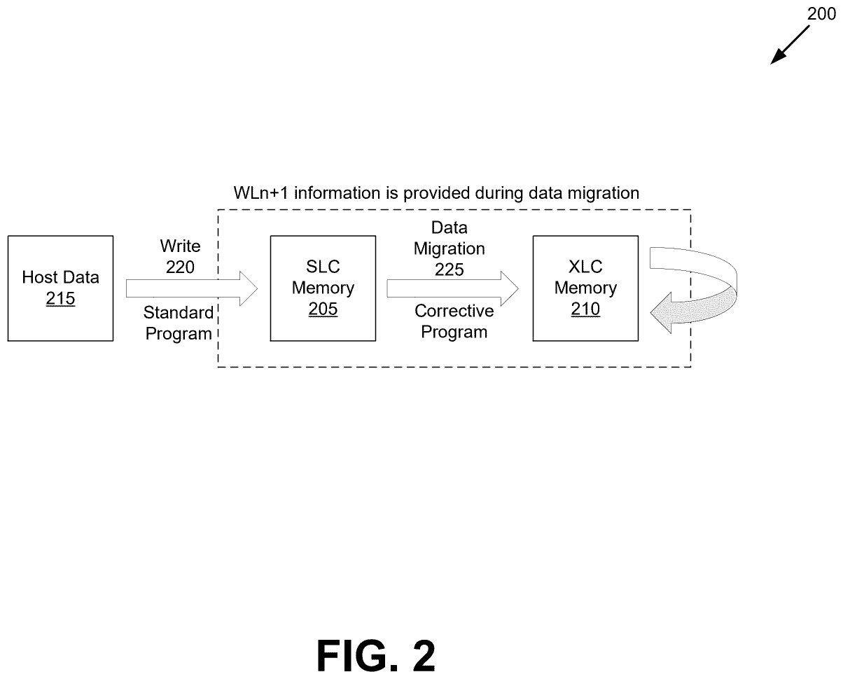

FIG. 2 is a sequence diagram illustrating an example method 200 of migrating data from single-level cell memory to multiple-level cell memory based on wordline information, in accordance with some aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 200 is performed by the data migration component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

A memory device may include SLC memory 205 and XLC memory 210. As described herein, SLC memory stores one bit of information per cell, which can make it faster, more reliable, and more durable than other types of memory. The single-bit storage means that each cell can be in one of two states (0 or 1), resulting in straightforward read and write processes that minimize the chances of errors. This simplicity can translate to higher endurance and faster write and read speeds. In contrast, XLC memory stores multiple bits per cell, thereby increasing data density in the memory device. However, this increased storage density may reduce reliability, speed, or durability of the memory device. XLC memory can be categorized based on the number of bits stored per cell. Multi-level cell (MLC) memory stores two bits per cell, allowing for four possible states (00, 01, 10, 11). Triple-level cell (TLC) memory stores three bits per cell, resulting in eight possible states (000 to 111). Quad-level cell (QLC) memory stores four bits per cell, leading to sixteen possible states (0000 to 1111). In some aspects, the XLC memory 210 is TLC memory. In some other aspects, the XLC memory 210 is another type of memory that stores multiple bits per cell. The processing logic may perform one or more write operations to store host data 215 in the SLC memory 205 and the XLC memory 210.

At operation 220, the processing logic writes the host data 215 to the SLC memory 205. For example, the processing logic may use a standard write operation to write the host data 215 to the SLC memory 205.

At operation 225, the processing logic performs a data migration operation to move data from the SLC memory 205 to the XLC memory 210. For example, the processing logic may move at least a subset of the host data 215 from the SLC memory 205 to the XLC memory 210 using a corrective program operation. During the corrective program operation, the processing logic identifies cells with deviating charge levels and rewrites the data to these cells to restore the correct charge levels. This operation may involve reading the data from the affected cells, correcting any detected errors using error correction codes, and then reprogramming the cells with the accurate data.

As described herein, a memory device may include a plurality of wordlines. A wordline is a control line in a memory device used to select a row of memory cells in an array for reading or writing operations. For example, the wordline may be a horizontal conductor that connects to the gates of a series of memory cells in the same row. When a specific wordline is activated, it allows access to the memory cells in that row for operations such as reading the stored data, writing new data, or erasing the data.

The data to be moved from the SLC memory 205 to the XLC memory 210 may be associated with a first wordline (WLn). For example, at least a subset of the host data 215 to be moved from the SLC memory 205 to the XLC memory 210 may be stored in one or more memory cells that are connected to the first wordline. The first wordline may be any wordline of the plurality of wordlines of the memory device. To move the data from the SLC memory 205 to the XLC memory 210 (for example, using the corrective program operation), the processing logic may obtain information from a second wordline (WLn+1) that is adjacent to the first wordline. The second wordline that is adjacent to the first wordline may be referred to as a neighbor wordline of the first wordline.

In some aspects, the processing logic may determine to move (for example, fold) data stored in an SLC source block. Therefore, the processing logic may retrieve data information associated with the second wordline from the SLC source block. The information associated with the second wordline can be retrieved from the SLC source block in advance of the data migration operation. For example, information indicating whether the second wordline is in a high state (1) or a low state (0) may be retrieved in advance of the data migration operation to move the data from the SLC memory 205 to the XLC memory 210. In some aspects, the information indicating whether the second wordline is in the high state or the low state may be a flag associated with the wordline that is set to the high value (1) or the low value (0). The information indicating whether the second wordline is in the high state or the low state may be provided to a latch of the memory device (for example, a NAND latch) in a corrective program mode of the memory device. In some aspects, such as in automotive applications, all data that is to be written to the XLC memory 210 (for example, TLC memory) may be written using corrective programming. Therefore, the host data 215 may first be written to the SLC memory 205 and then moved (for example, folded) from the SLC memory 205 to the XLC memory 210 using the corrective programming. In some aspects, a corrective program trim, which can be used to adjust programming characteristics of non-volatile memory cells of the memory device, can be based on a program erase count (PEC) of the memory cells. This may reflect the lateral charge migration that is more impactful in a beginning of life of the memory device.

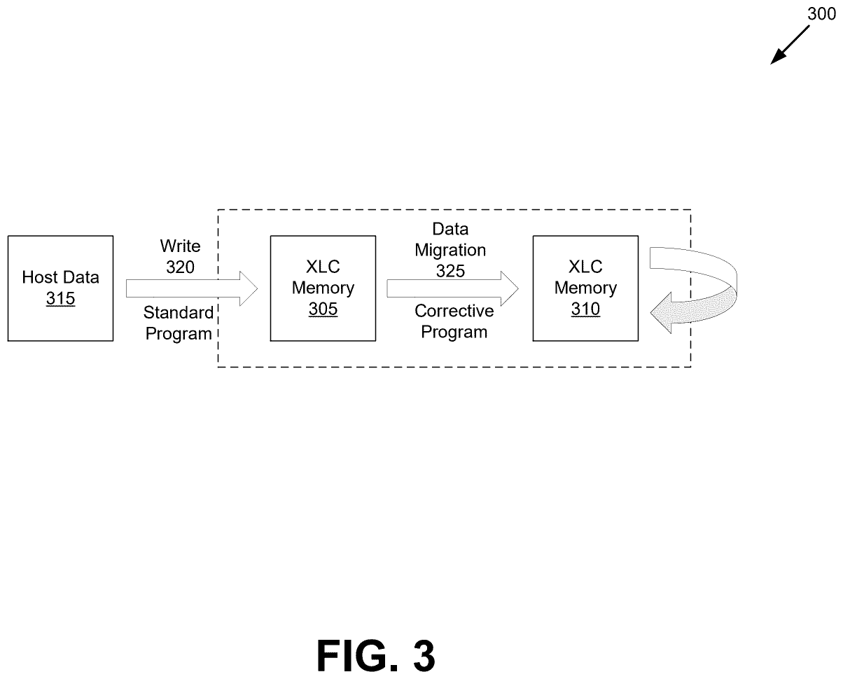

FIG. 3 is a sequence diagram illustrating an example method 300 of migrating data from first multiple-level cell memory to second multiple-level cell memory based on wordline information, in accordance with some aspects of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 300 is performed by the data migration component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

A memory device may include first XLC memory (shown as XLC memory 305) and second XLC memory (shown as XLC memory 310). In some aspects, the XLC memory 305 and the XLC memory 310 are TLC memory. In some other aspects, the XLC memory 305 and the XLC memory 310 are other types of memory that store multiple bits per cell. The processing logic may perform one or more write operations to store host data 315 in the XLC memory 305 and the XLC memory 310.

At operation 320, the processing logic writes the host data 315 to the XLC memory 305. For example, the processing logic may use a standard write operation to write the host data 315 to the XLC memory 305.

At operation 325, the processing logic performs a data migration operation to move data from the XLC memory 305 to the XLC memory 310. For example, the processing logic may move at least a subset of the host data 315 from the XLC memory 305 to the XLC memory 310 using a corrective program operation.

In some aspects, the data migration may be performed in accordance with a garbage collection operation. Garbage collection is a maintenance process that manages the deletion and consolidation of data in memory devices. When files are deleted, the memory cells holding the data are not immediately cleared; instead, the data is marked as invalid. The garbage collection process identifies these invalid blocks and erases them, making space available for new data. This process helps in reducing write amplification, maintaining device performance, and prolonging the lifespan of the memory by minimizing wear on the memory cells.

In some aspects, the data migration may be performed in accordance with a media scan operation. Media scan is a diagnostic procedure used in memory devices to ensure data integrity and detect potential issues. During a media scan, the memory device systematically reads stored data and checks for errors or signs of corruption that might have occurred due to wear or other factors. If errors are detected, the memory device can attempt to correct them using error correction codes or can move the data to healthy blocks. Regular media scans help in maintaining the reliability of the memory device by proactively identifying and addressing issues before they lead to data loss.

In some aspects, the data migration may be performed in accordance with an active folding operation. Active folding in memory devices refers to a technique where the physical layout of memory cells is dynamically reconfigured to optimize performance and efficiency. This approach allows for the adjustment of signal paths to reduce latency, improve access times, and enhance overall device performance. By actively rearranging the memory cells, power consumption can be reduced and the density of memory storage on a chip can be increased. Active folding adapts to varying operational conditions, providing a more flexible and efficient use of the available memory space.

The data to be moved from the XLC memory 305 to the XLC memory 310 may be associated with a first wordline (WLn). For example, at least a subset of the host data 315 to be moved from the XLC memory 305 to the XLC memory 310 may be stored in one or more memory cells that are connected to the first wordline. The first wordline may be any wordline of the plurality of wordlines of the memory device. To move the data from the XLC memory 305 to the XLC memory 310, the processing logic may obtain information from a second wordline (WLn+1) that is adjacent to the first wordline. The second wordline that is adjacent to the first wordline may be referred to as a neighbor wordline of the first wordline. The processing logic may obtain the information associated with the second wordline during the data migration from the XLC memory 305 to the XLC memory 310. In a first example, the processing logic may decode information associated with the second wordline, such as whether the second wordline is in a high state or a low state, from a controller of the memory device, and may store the information in a latch of the memory device (for example, a NAND latch). In a second example, the processing logic may perform an on-chip read to read the information associated with the second wordline, such as whether the second wordline is in the high state or the low state, and may store the information in a latch of the memory device (for example, a NAND latch).

In some aspects, data retention behavior may differ depending on whether or not corrective programming is performed. Therefore, the processing logic may pool labels indicating standard programming or corrective programming for different media scan or bit-flipping scan cadences (such as bit-flipping error avoidance sets). In this example, a corrective program pool may be used less frequently with media and bit-flipping scans.

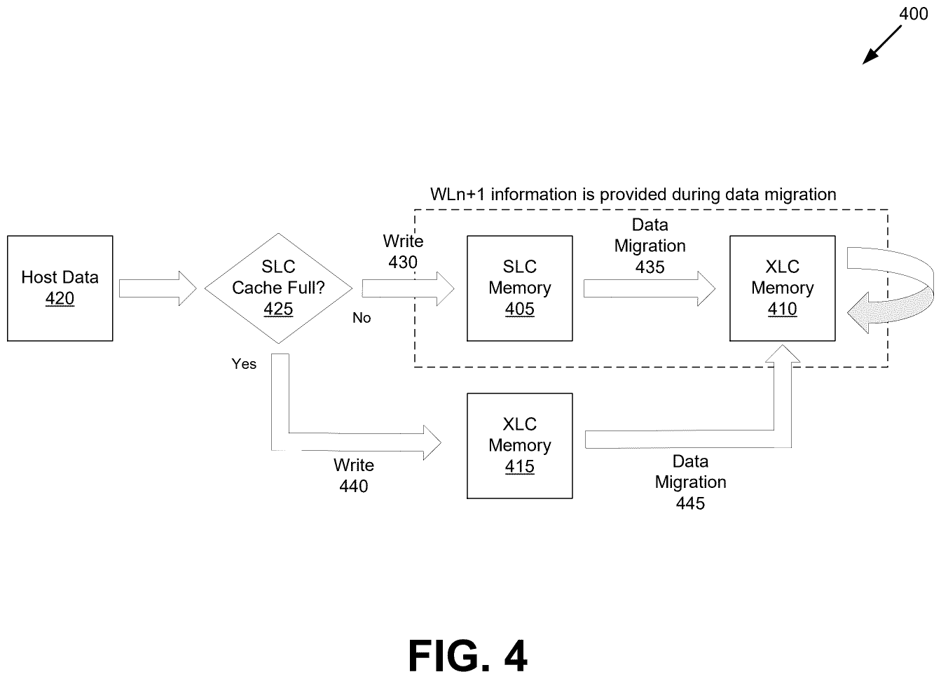

FIG. 4 is a sequence diagram illustrating an example method 400 of migrating data based on wordline information and a characteristic of a single-level cell cache, in accordance with some aspects of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 400 is performed by the data migration component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

A memory device may include SLC memory 405, first XLC memory (shown as XLC memory 410) and second XLC memory (shown as XLC memory 415). In some aspects, the XLC memory 410 and the XLC memory 415 are TLC memory. In some other aspects, the XLC memory 410 and the XLC memory 415 are other types of memory that store multiple bits per cell. The processing logic may perform one or more write operations to store host data 420 in one or more of the SLC memory 405, the XLC memory 410, and the XLC memory 415.

At operation 425, the processing logic may determine whether an SLC cache is full. An SLC cache is a storage area (for example, a small, high-speed storage area) that stores data associated with the SLC memory 405. This may improve overall system performance by enabling data (such as frequently accessed SLC data) to be quickly accessed from the SLC cache.

At operation 430, the processing logic may write data to the SLC memory 405 responsive to determining that the SLC cache is not full. For example, the processing logic may determine that the SLC cache is not full and may use a standard write operation to write the host data 420 to the SLC memory 405.

At operation 435, the processing logic performs a data migration operation to move data from the SLC memory 405 to the XLC memory 410. For example, the processing logic may move at least a subset of the host data 420 from the SLC memory 405 to the XLC memory 410 using a corrective program operation.

In some aspects, the data migration operation 435 may be similar or identical to the data migration operation 225 described in connection with FIG. 2. The data to be moved from the SLC memory 405 to the XLC memory 410 may be associated with a first wordline (WLn). To move the data from the SLC memory 405 to the XLC memory 410 (for example, using the corrective program operation), the processing logic may obtain information from a second wordline (WLn+1) that is adjacent to the first wordline. The second wordline that is adjacent to the first wordline may be referred to as a neighbor wordline of the first wordline. The processing logic may retrieve data information associated with the second wordline from the SLC source block. The information associated with the second wordline can be retrieved from the SLC source block in advance of the data migration operation. For example, information indicating whether the second wordline is in a high state or a low state may be retrieved in advance of the data migration operation to move the data from the SLC memory 405 to the XLC memory 410. The information indicating whether the second wordline is in the high state or the low state may be provided to a latch of the memory device (for example, a NAND latch) in a corrective program mode of the memory device.

At operation 440, the processing logic may write data to the XLC memory 415 responsive to determining that the SLC cache is full. For example, the processing logic may determine that the SLC cache is full and may use a standard write operation to write the host data 420 to the XLC memory 415.

At operation 445, the processing logic performs a data migration operation to move data from the XLC memory 415 to the XLC memory 410. For example, the processing logic may move at least a subset of the host data 420 from the XLC memory 415 to the XLC memory 410 using a corrective program operation.

In some aspects, the data migration operation 445 may be similar or identical to the data migration operation 225 described in connection with FIG. 2. For example, the data migration may be performed in accordance with a garbage collection operation, a media scan operation, or an active folding operation. The data to be moved from the XLC memory 415 to the XLC memory 410 may be associated with a first wordline (WLn). For example, at least a subset of the host data 420 to be moved from the XLC memory 415 to the XLC memory 410 may be stored in one or more memory cells that are connected to the first wordline. The first wordline may be any wordline of the plurality of wordlines of the memory device. To move the data from the XLC memory 415 to the XLC memory 410, the processing logic may obtain information from a second wordline (WLn+1) that is adjacent to the first wordline. The second wordline that is adjacent to the first wordline may be referred to as a neighbor wordline of the first wordline. The processing logic may obtain the information associated with the second wordline during the data migration from the XLC memory 415 to the XLC memory 410. In a first example, the processing logic may decode information associated with the second wordline, such as whether the second wordline is in a high state or a low state, from a controller of the memory device, and may store the information in a latch of the memory device (for example, a NAND latch). In a second example, the processing logic may perform an on-chip read to read the information associated with the second wordline, such as whether the second wordline is in the high state or the low state, and may store the information in a latch of the memory device (for example, a NAND latch).

As described herein, an XLC memory system (for example, a TLC NAND system) can leverage corrective programming to improve data retention trigger rates. To apply the corrective programming, processing logic may obtain information from neighboring wordlines to be used while performing the XLC programming. Using SLC-to-TLC folding (for example, as described in FIG. 2), the processing logic may extract the adjacent wordline information using data scrambling. In contract, using TLC-to-TLC folding, (for example as described in FIG. 3), the data can be retrieved from the memory system or from an on-chip read. For the processing logic to have mode standard programming modes and corrective programming modes, the blocks may need to be separated, for example, since they use different system scanning cadences. Additionally, or alternatively, a corrective program trim can be based on a program erase count of the memory cells. This may reflect the lateral charge migration that is more impactful in a beginning of life of the memory device.

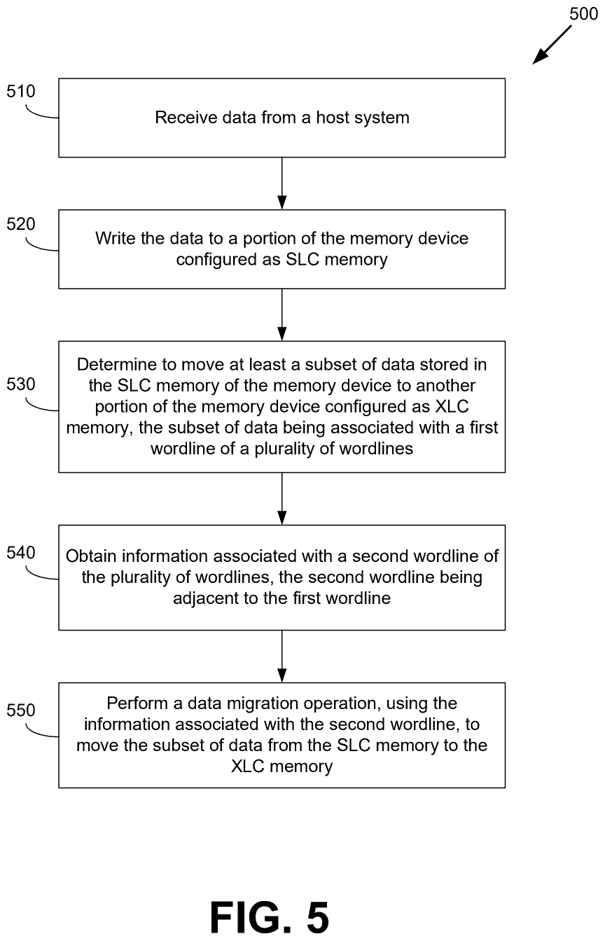

FIG. 5 is a flow diagram of an example method 500 of migrating data from single-level cell memory to multiple-level cell memory based on wordline information, in accordance with some aspects of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 500 is performed by the data migration component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 510, the processing logic receives data from a host system, such as host system 120.

At operation 520, the processing logic writes the data to a portion of the memory device, such as memory device 130, configured as SLC memory.

At operation 530, the processing logic determines to move at least a subset of data stored in the SLC memory of the memory device to another portion of the memory device configured as XLC memory. The subset of data is associated with a first wordline of the plurality of wordlines. In some implementations, the XLC memory is TLC memory.

At operation 540, the processing logic obtains information associated with a second wordline of the plurality of wordlines. The second wordline may be adjacent to the first wordline. In some implementations, the information associated with the second wordline indicates whether the second wordline is in a high state or a low state. In some implementations, obtaining the information associated with the second wordline comprises retrieving the information from one or more SLC source blocks of the SLC memory. In some implementations, obtaining the information associated with the second wordline comprises retrieving the information using a data scrambling operation.

At operation 550, the processing logic performs a data migration operation, using the information associated with the second wordline, to move the subset of data from the SLC memory to the XLC memory. In some implementations, the data migration operation is associated with a corrective program operation and the information associated with the second wordline is stored in a latch of the memory device. In some implementations, the corrective program operation is based on a program erase cycle of the SLC memory of the memory device.

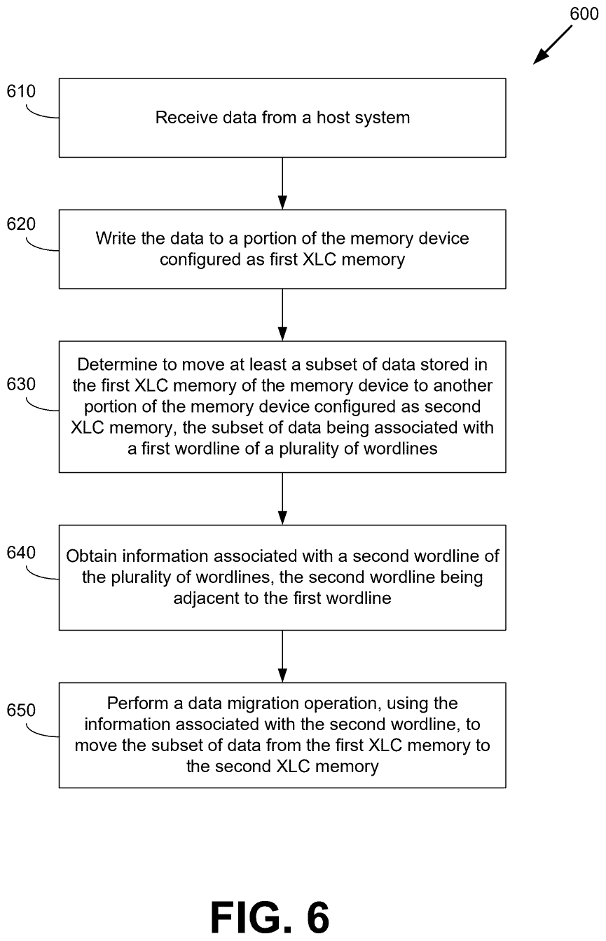

FIG. 6 is a flow diagram of an example method 600 of migrating data from first multiple-level cell memory to second multiple-level cell memory based on wordline information, in accordance with some aspects of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 600 is performed by the data migration component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 610, the processing logic receives data from a host system, such as host system 120.

At operation 620, the processing logic writes the data to a portion of the memory device, such as memory device 130, configured as first XLC memory. In some implementations, the first SLC memory is TLC memory.

At operation 630, the processing logic determines to move at least a subset of data stored in the first XLC memory of the memory device to another portion of the memory device configured as second XLC memory. The subset of data is associated with a first wordline of the plurality of wordlines. In some implementations, the second XLC memory is TLC memory.

At operation 640, the processing logic obtains information associated with a second wordline of the plurality of wordlines. The second wordline may be adjacent to the first wordline. In some implementations, the information associated with the second wordline indicates whether the second wordline is in a high state or a low state. In some implementations, obtaining the information associated with the second wordline comprises decoding, by a system controller, the information associated with the second wordline, and storing, by the system controller in a latch of the memory device, the information associated with the second wordline. In some implementations, obtaining the information associated with the second wordline comprises performing, by a memory device controller, an on-chip read to read the information associated with the second wordline, and storing, by the memory device controller in a latch of the memory device, the information associated with the second wordline.

At operation 650, the processing logic performs a data migration operation, using the information associated with the second wordline, to move the subset of data from the first XLC memory to the second XLC memory. In some implementations, the data migration operation is associated with a media scan operation or a garbage collection. In some implementations, the data migration operation is associated with a corrective programming operation.

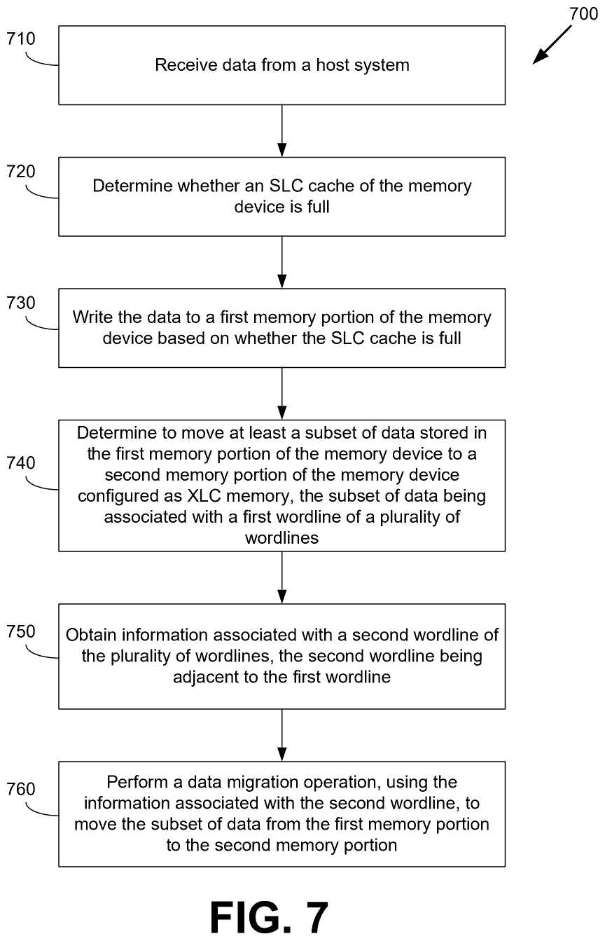

FIG. 7 is a flow diagram of an example method 700 of migrating data based on wordline information and a characteristic of a single-level cell cache, in accordance with some aspects of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 700 is performed by the data migration component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 710, the processing logic receives data from a host system, such as host system 120.

At operation 720, the processing logic determines whether a single-level cell (SLC) cache of the memory device, such as memory device 130, is full.

At operation 730, the processing logic writes the data to a first memory portion of the memory device based on whether the SLC cache of the memory device is full. In some implementations, the first memory portion of the memory device is SLC memory. In some other implementations, the first memory portion of the memory device is XLC memory.

At operation 740, the processing logic determines to move at least a subset of data stored in the first memory portion of the memory device to a second memory portion of the memory device configured as XLC memory. The subset of data is associated with a first wordline of the plurality of wordlines.

At operation 750, the processing logic obtains information associated with a second wordline of the plurality of wordlines. The second wordline may be adjacent to the first wordline. In some implementations, the information associated with the second wordline indicates whether the second wordline is in a high state or a low state.

At operation 760, the processing logic performs a data migration operation, using the information associated with the second wordline, to move the subset of data from the first memory portion to the second memory portion. In some implementations, the data migration operation is associated with a media scan operation or a garbage collection. In some implementations, the data migration operation is associated with a corrective programming operation.

In some implementations, the first memory portion is SLC memory, and writing the data to the first memory portion based on whether the SLC cache of the memory device is full comprises writing the data to the SLC memory based on the SLC cache of the memory device not being full. In some other implementations, the first memory portion is other XLC memory, and writing the data to the first memory portion based on whether the SLC cache of the memory device is full comprises writing the data to the other XLC memory based on the SLC cache of the memory device being full.

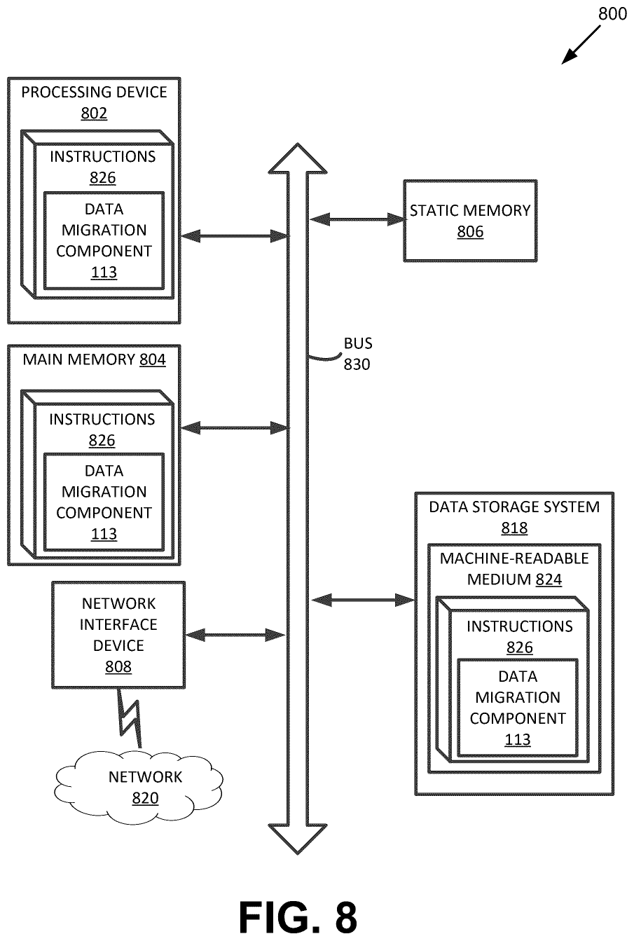

FIG. 8 illustrates an example machine of a computer system 800 within which a set of instructions, for causing the machine to perform any one or more of the methodologies discussed herein, can be executed. In some aspects, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the data migration component 113 of FIG. 1). In alternative aspects, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1.

In some aspects, the instructions 826 include instructions to implement functionality corresponding to the data migration component 113 of FIG. 1). While the machine-readable storage medium 824 is shown in an example aspect to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some aspects, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, aspects of the disclosure have been described with reference to specific example aspects thereof. It will be evident that various modifications can be made thereto without departing from the broader spirit and scope of aspects of the disclosure as set forth in the following claims. The specification and drawings are, accordingly, to be regarded in an illustrative sense rather than a restrictive sense.

What is claimed is:

1. A system comprising:
a memory device comprising a plurality of wordlines forming an array of memory cells; and
a processing device, coupled with the memory device, configured to perform operations comprising:
receiving data from a host system;
writing the data to a portion of the memory device configured as single-level cell (SLC) memory;
determining to move at least a subset of data stored in the SLC memory of the memory device to another portion of the memory device configured as multiple-level cell (XLC) memory, the subset of data being associated with a first wordline of the plurality of wordlines;
obtaining information associated with a second wordline of the plurality of wordlines, wherein the second wordline is adjacent to the first wordline; and
performing a data migration operation, using the information associated with the second wordline, to move the subset of data from the SLC memory to the XLC memory.

2. The system of claim 1, wherein the information associated with the second wordline indicates whether the second wordline is in a high state or a low state.

3. The system of claim 1, wherein the XLC memory is triple-level cell (TLC) memory.

4. The system of claim 1, wherein obtaining the information associated with the second wordline comprises retrieving the information from one or more SLC source blocks of the SLC memory.

5. The system of claim 1, wherein the data migration operation is associated with a corrective program operation, and wherein the information associated with the second wordline is stored in a latch of the memory device.

6. The system of claim 5, wherein the corrective program operation is based on a program erase cycle of the SLC memory of the memory device.

7. The system of claim 1, wherein obtaining the information associated with the second wordline comprises retrieving the information using a data scrambling operation.

8. A system comprising:
a memory device comprising a plurality of wordlines forming an array of memory cells; and
a processing device, coupled with the memory device, configured to perform operations comprising:
receiving data from a host system;
writing the data to a portion of the memory device configured as first multiple-level cell (XLC) memory;
determining to move at least a subset of data stored in the first XLC memory of the memory device to another portion of the memory device configured as second XLC memory, the subset of data being associated with a first wordline of the plurality of wordlines;
obtaining information associated with a second wordline of the plurality of wordlines, wherein the second wordline is adjacent to the first wordline; and
performing a data migration operation, using the information associated with the second wordline, to move the subset of data from the first XLC memory to the second XLC memory.

9. The system of claim 8, wherein the information associated with the second wordline indicates whether the second wordline is in a high state or a low state.

10. The system of claim 8, wherein the XLC memory is triple-level cell (TLC) memory.

11. The system of claim 8, wherein the data migration operation is associated with a media scan operation or a garbage collection.

12. The system of claim 8, wherein the data migration operation is associated with a corrective programming operation.

13. The system of claim 8, wherein obtaining the information associated with the second wordline comprises:
decoding, by a system controller, the information associated with the second wordline; and
storing, by the system controller in a latch of the memory device, the information associated with the second wordline.

14. The system of claim 8, wherein obtaining the information associated with the second wordline comprises:
performing, by a memory device controller, an on-chip read to read the information associated with the second wordline; and
storing, by the memory device controller in a latch of the memory device, the information associated with the second wordline.

15. A system comprising:
a memory device comprising a plurality of wordlines forming an array of memory cells; and
a processing device, coupled with the memory device, configured to perform operations comprising:
receiving data from a host system;
determining whether a single-level cell (SLC) cache of the memory device is full;
writing the data to a first memory portion of the memory device based on whether the SLC cache of the memory device is full;
determining to move at least a subset of data stored in the first memory portion of the memory device to a second memory portion of the memory device configured as multiple-level cell (XLC) memory, the subset of data being associated with a first wordline of the plurality of wordlines;
obtaining information associated with a second wordline of the plurality of wordlines, wherein the second wordline is adjacent to the first wordline; and
performing a data migration operation, using the information associated with the second wordline, to move the subset of data from the first memory portion to the second memory portion.

16. The system of claim 15, wherein the information associated with the second wordline indicates whether the second wordline is in a high state or a low state.

17. The system of claim 15, wherein the first memory portion is SLC memory, and wherein writing the data to the first memory portion based on whether the SLC cache of the memory device is full comprises writing the data to the SLC memory based on the SLC cache of the memory device not being full.

18. The system of claim 15, wherein the first memory portion is other XLC memory, and wherein writing the data to the first memory portion based on whether the SLC cache of the memory device is full comprises writing the data to the other XLC memory based on the SLC cache of the memory device being full.

19. The system of claim 18, wherein the data migration operation is associated with a media scan operation or a garbage collection.

20. The system of claim 18, wherein the data migration operation is associated with a corrective programming operation.
